(19) United States
(12) Patent Application Publication
(10) Pub. No.: US 2022/0297638 A1
(43) Pub. Date: Sep. 22, 2022

(54) DIVERTING AIR FROM A CARGO AREA OF A VEHICLE

(71) Applicant: Pony Al Inc., Grand Cayman (KY)

(72) Inventors: Peter G. Diehl, Shanghai (CN); Luke Morrow, Gilroy, CA (US)

(21) Appl. No.: 17/204,268

(22) Filed: Mar. 17, 2021

(51) Int. Cl. B60S 1/56

(52) U.S. Cl. CPC B60S 1/56

(57) ABSTRACT

Sensor maintenance tasks are performed by diverting air from one region of a vehicle to another region of the vehicle. A blower provided in a cargo area of a vehicle can divert hot air from the cargo area via one or more conduits to a sensor assembly located in another region of the vehicle such as a rooftop sensor assembly. The sensor assembly may include cameras enclosed in a sensor housing to protect the cameras from exposure to the natural elements. The sensor housing may include a transparent window via which the camera is provided with a field-of-view (FOV) of the external environment. The diverted hot air can be directed/targeted to interior and exterior surfaces of the transparent window to provide various cleaning functions including reducing/removing condensation from the interior surface of the window and removing debris or the like from the exterior surface of the window.

### FIELD OF THE INVENTION

The disclosed technology relates generally to sensor maintenance for a vehicle, and more particularly, in some embodiments, to diverting air from one region of a vehicle, such as a cargo area, to another region of the vehicle to provide one or more cleaning functions for one or more sensors.

### BACKGROUND

Autonomous vehicles, also referred to as driverless vehicles, are vehicles capable of making autonomous driving decisions without requiring human action or input. In general, autonomous vehicles include a variety of various types of sensors that provide sensor data, which is analyzed/processed/manipulated by software/firmware/hardware executing onboard the vehicle or in a remote environment, in order to make autonomous driving decisions such as when and how much to accelerate or decelerate, when and how much to turn the vehicle, when to brake the vehicle and what braking distance to maintain, and so forth.

An autonomous vehicle can include a variety of different types of on-board sensors including, for example, cameras, light detection and ranging (LiDAR) sensors, radar sensors, Global Positioning System (GPS) devices, sonar-based sensors, ultrasonic sensors, accelerometers, gyroscopes, magnetometers, inertial measurement units (IMUs), and far infrared (FIR) sensors. On-board vehicle sensors disposed on an exterior of a vehicle may be provided in or integrated with protective housing to protect the sensors from damage from the natural elements. Despite being encased in housing, some on-board sensors can experience diminished performance as a result of environmental factors to which the housing is subjected. Technical solutions that mitigate the effect of such factors on sensor performance are described herein.

### SUMMARY

Example embodiments of the disclosed technology include methods, systems, apparatuses, techniques, and algorithms for performing sensor maintenance tasks by diverting air from one region of a vehicle to another region of the vehicle. In example embodiments, hot air in a cargo area of a vehicle (e.g., a trunk) can be diverted by a blower to a sensor assembly such as a rooftop sensor assembly located in another region of the vehicle. The sensor assembly may include various types of sensors such as LiDAR sensor as well as one or more cameras. At least some of the sensors (e.g., the cameras) may be enclosed in a sensor housing to protect the sensors from the environment external to the vehicle (the LiDAR may have its own separate housing). The sensor housing that enclosed the cameras may include a respective glass window that opposes each camera and that provides a field-of-view (FOV) for the camera of a portion of the external environment.

In example embodiments, hot air from the vehicle cargo area can be diverted to the sensor assembly to perform multiple sensor maintenance/cleaning tasks. For instance, the hot air may be delivered to an interior region of the sensor housing of the sensor assembly to reduce/remove condensation from the interior surfaces of the glass windows. In addition, in some example embodiments, the travel path of the air may be adjusted by a deflector to cause the air—after contact with an interior surface of a glass window—to be targeted to an exterior surface of the glass window to remove debris, moisture, etc. Thus, example embodiments of the disclosed technology obviate the need for separate blowers for removing condensation and debris from the glass surfaces of the aforementioned sensor housing. This reduction in the amount of equipment needed to perform various sensor maintenance tasks reduces the weight of the vehicle and thereby increases the efficiency and driving range for the vehicle, which in the case of autonomous vehicles, is of particular importance.

In an example embodiment, a computer-implemented method for sensor maintenance is disclosed. The method includes receiving sensor data from one or more sensors configured to monitor at least a first region of a vehicle and determining, based on the sensor data, one or more parameters for diverting air from the first region of the vehicle to a second region of the vehicle different from the first region. The method further includes causing the air to be diverted from the first region of the vehicle to the second region of the vehicle based on the one or more parameters.

In an example embodiment, determining the one or more parameters includes determining a blower motor speed based on the sensor data, and causing the air to be diverted from the first region of the vehicle to the second region of the vehicle includes causing a motor of a blower in the first region of the vehicle to operate at the determined blower motor speed.

In an example embodiment, the sensor data includes temperature data indicative of a temperature of the air in the first region of the vehicle, and determining the blower motor speed based on the sensor data includes increasing the blower motor speed as the temperature of the air increases.

In an example embodiment, the one or more sensors includes at least one sensor configured to monitor the second region of the vehicle, and wherein the blower motor speed is determined based at least in part on a respective portion of the sensor data that is received from the at least one sensor.

In an example embodiment, the second region of the vehicle includes a sensor assembly that includes a camera and a protective shield that protects the camera from an external environment to the vehicle. Further, in an example embodiment, the respective portion of the sensor data that is received from the at least one sensor includes data indicative of at least one of an amount of moisture or an amount of debris present on the protective shield.

In an example embodiment, determining the blower motor speed based on the sensor data includes increasing the blower motor speed as the amount of moisture or the amount of debris present on the protective shield increases.

In an example embodiment, the protective shield is provided as part of a sensor housing that encloses the camera, and the protective shield includes an interior glass surface that opposes the camera and an exterior glass surface exposed to the external environment.

In an example embodiment, causing the air to be diverted from the first region of the vehicle to the second region of the vehicle includes causing the air to be diverted from the first region of the vehicle to the interior glass surface of the sensor assembly via one or more conduits.

In an example embodiment, the example method further includes causing the air to be deflected after contact with the interior glass surface to redirect the air to the exterior glass surface.

In an example embodiment, the first region of the vehicle is a cargo area of the vehicle that includes one or more electrical components that generate heat.

In an example embodiment, a system for sensor maintenance is disclosed. The system includes at least one processor and at least one memory storing computer-executable instructions. The at least one processor is configured to access the at least one memory and execute the computer-executable instructions to perform a set of operations including receiving sensor data from one or more sensors configured to monitor at least a first region of a vehicle, determining, based on the sensor data, one or more parameters for diverting air from the first region of the vehicle to a second region of the vehicle different from the first region, and causing the air to be diverted from the first region of the vehicle to the second region of the vehicle based on the one or more parameters. The above-described system is further configured to perform any of the operations/functions and may include any of the additional features/aspects of example embodiments of the invention described above in relation to example methods of the invention.

In an example embodiment, an apparatus for sensor maintenance is disclosed. The apparatus includes a blower provided in a first region of a vehicle, one or more conduits for carrying a fluid, and a controller. In an example embodiment, the controller is configured to: receive sensor data from one or more sensors configured to monitor at least the first region of the vehicle and activate the blower based on the sensor data to cause air in the first region of the vehicle to be diverted via the one or more conduits to a second region of the vehicle.

In an example embodiment, the apparatus includes the one or more sensors.

In an example embodiment, the one or more sensors includes a first sensor in the first region of the vehicle and a second sensor in the second region of the vehicle.

In an example embodiment, the second region of the vehicle is non-contiguous with the first region of the vehicle.

In an example embodiment, a computer program product for sensor maintenance is disclosed. The computer program product includes a non-transitory computer-readable medium readable by a processing circuit. The non-transitory computer-readable medium stores instructions executable by the processing circuit to cause a method to be performed. The method includes receiving sensor data from one or more sensors configured to monitor at least a first region of a vehicle and determining, based on the sensor data, one or more parameters for diverting air from the first region of the vehicle to a second region of the vehicle different from the first region. The method further includes causing the air to be diverted from the first region of the vehicle to the second region of the vehicle based on the one or more parameters. The above-described computer program product is further configured to perform any of the operations/functions and may include any of the additional features/aspects of example embodiments of the invention described above in relation to example methods of the invention.

These and other features of the systems, apparatuses, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example configuration of an apparatus for performing sensor maintenance that is adapted to divert air from a vehicle cargo area to a sensor assembly located in a different region of the vehicle in accordance with an example embodiment of the disclosed technology.

FIG. 2 illustrates an example configuration of an apparatus that is adapted to utilize air diverted from another region of a vehicle to perform a cleaning function with respect to a transparent portion of a sensor housing in accordance with an example embodiment of the disclosed technology.

FIG. 3A is a data flow and block diagram illustrating operation of an apparatus adapted to divert air from a vehicle cargo area to another region of a vehicle in accordance with an example embodiment of the disclosed technology.

FIG. 3B is a data flow and block diagram illustrating operation of an apparatus adapted to receive air diverted from a vehicle cargo area and utilize the diverted air to perform a cleaning function with respect to a transparent portion of a sensor housing in accordance with an example embodiment of the disclosed technology.

FIG. 4 is a process flow diagram of an illustrative method for diverting air from a vehicle cargo area to another region of a vehicle in accordance with an example embodiment of the disclosed technology.

FIG. 5 is a process flow diagram of an illustrative method for receiving air diverted from a vehicle cargo area and utilizing the diverted air to perform a cleaning function with respect to a transparent portion of a sensor housing in accordance with an example embodiment of the disclosed technology.

FIG. 6 is a schematic block diagram illustrating an example networked architecture configured to implement example embodiments of the disclosed technology.

### DETAILED DESCRIPTION

Overview

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments of the invention overcome technical problems specifically arising in the realm of computer-based technology, and more specifically, in the realm of autonomous vehicle technology. Autonomous vehicles are vehicles capable of making autonomous driving decisions without the aid of a human driver. In some cases, governmental regulations, safety/liability concerns, or the like may dictate that one or more humans be present in an autonomous vehicle during operation in order to potentially override autonomous operation of the vehicle, if deemed necessary to ensure vehicle occupant safety. In other cases, however, an autonomous vehicle may operate without the presence of any human capable of taking over manual control of the vehicle. For instance, an autonomous vehicle ride-sharing or taxi service may provide fully autonomous vehicles capable of transporting vehicle occupants (e.g., passengers) without the aid of a human driver. Example embodiments of the disclosed technology have particular relevance and importance for autonomous vehicles given the large number of sensors such vehicles are equipped with to enable autonomous vehicle operations. It should be appreciated, however, that embodiments of the disclosed technology are widely applicable to any type of vehicle, and in particular, to any vehicle equipped with a sensor that requires a cleaning operation to ensure efficient performance of the sensor.

As previously noted, autonomous vehicles require a large number of sensors of various types to capture the breadth of sensor data needed to perform the types of complex data processing that enables autonomous vehicle operations including, without limitation, object perception, object tracking, vehicle navigation, and the like. These sensors can include, without limitation, cameras; LiDARs; radars; GPS devices; sonar-based sensors; ultrasonic sensors; inertial sensors such as accelerometers, gyroscopes, magnetometers, and IMUs; FIR sensors; and the like. In some cases, certain sensors (e.g., IMUs) may be located within an interior of a vehicle or may otherwise be shielded/protected from exposure to the external environment and potentially harsh weather such as rain, wind, snow, extreme temperatures, or the like. Other sensors, however, may be located external to the vehicle, in which case, the sensors may be enclosed within a housing/casing that protects/shields the sensors from the external environment.

For instance, a sensor assembly that includes a LiDAR and multiple cameras positioned circumferentially around the LiDAR may be located on an exterior surface of an autonomous vehicle such as the roof of the vehicle. In some example embodiments, the cameras may be enclosed in a housing that protects the cameras, and in particular the relatively delicate camera lenses, from potentially harsh conditions in the environment external to the vehicle. While such a sensor assembly may be located, at least in part, exterior to the vehicle, the sensor assembly—including the cameras contained therein—may be treated as being located in a region of the vehicle, as that term is used herein.

The sensor housing may include a respective transparent portion that opposes each camera and that provides an FOV for the camera of a portion of the external environment. The transparent portion may be formed, for example, of a glass material, a plastic material, or the like. Example embodiments may be described herein assuming that the transparent portion is a glass window or a similar structure; however, it should be appreciated that any transparent material(s) may be used.

It is important for the glass windows in the sensor housing to remain unobscured so that the cameras can capture clear images of the vehicle's external environment through the FOVs provided by the glass windows. Unobscured views are necessary for the cameras to capture images of suitable quality for object perception processing and the like. There are, however, a number of factors that can cause the glass windows to become obscured during vehicle operation. For example, condensation can develop on an interior surface of a glass window (e.g., a surface facing an interior region of the sensor housing) due to a temperature differential between the interior of the sensor housing and the external environment. In addition, an exterior surface of a glass window can become obscured by dirt, liquid (e.g., water droplets), or other types of debris.

In order to maintain the glass windows in a relatively unobscured state, fans have conventionally been used to provide a cleaning function for the interior and exterior surfaces of the glass windows. In particular, a first fan may be located so as to target air to an interior surface of a glass window to prevent condensation from developing on the interior surface, and a second fan may be located so as to target air to an exterior surface of the glass window to mitigate/prevent debris accumulation on the exterior surface. In some cases, a first set of multiple fans may be required to provide a cleaning function to the interior surfaces of multiple glass windows and a second set of multiple fans may be required to provide a cleaning function to the exterior surfaces of the glass windows. As used herein, a cleaning function may refer to any of a subset of sensor maintenance tasks that may be performed to reduce or remove, from one or more surfaces, any object, contaminant, or the like that may degrade sensor performance. A sensor cleaning function may refer to something done to a sensor component itself (e.g., cleaning a camera lens) or to something done to another vehicle component that improves the efficiency of a sensor's operation (e.g., removing condensation from a glass window that provides an FOV for a camera; removing debris, liquid, etc. from the glass window, etc.).

Conventional sensor maintenance techniques that utilize multiple blowers/fans as described above present a number of technical problems and challenges. In particular, the fans add weight to the vehicle, which impacts the efficiency of the vehicle, and thus, the vehicle's driving range. This is particularly disadvantageous in the case of autonomous vehicles, for which driving range is a critical differentiator. In addition, the introduction of more vehicle equipment—in this case, multiple fans to provide cleaning functions for the glass windows of a sensor housing—creates the technical problem of more potential points of failure within the vehicle.

Example embodiments of the invention described herein provide technical solutions to at least the aforementioned technical problems associated with conventional techniques for sensor maintenance, particularly as they relate to providing a cleaning function to transparent portions of a sensor housing that provide FOVs to cameras contained therein. In particular, example embodiments of the invention relate to methods, systems, apparatuses, computer program products, techniques, and algorithms for performing sensor maintenance tasks by diverting air from one region of a vehicle to another region of the vehicle. In example embodiments, the air can be diverted by a blower from a cargo area of a vehicle (e.g., a trunk) to a sensor assembly located in another region of the vehicle such as a rooftop sensor assembly.

In particular, in example embodiments, a blower provided in a cargo area of a vehicle may be operated to cause air within the cargo area to be diverted to an inlet of a conduit (e.g., a tube) that leads out of the cargo area. The air in the cargo area may be hot from heat generated by electrical components in the cargo area. For instance, in the case of an autonomous vehicle, the cargo area may contain a fair amount of computing equipment needed to perform the complex processing tasks/calculations required to enable autonomous vehicle operation. This computing equipment can emit heat that causes the temperature of the air in the cargo area to rise.

The air may travel from the cargo area through the conduit—and potentially through one or more additional conduits—until it arrives at the aforementioned sensor assembly. The air may exit an outlet into an interior region of the sensor assembly. In example embodiments, the hot air may perform a defrosting/defogging function to cause condensation on the interior surfaces of the glass windows to evaporate. The condensation may be in the form of a “fogging up” of the glass windows of the sensor assembly or in the form of liquid droplets. In addition, in example embodiments, after contact with the interior surface of a glass window, the incoming hot air may be redirected towards an exterior surface of the glass window to provide a cleaning function such as to remove debris, water, moisture, and the like from the exterior surface. In example embodiments, a deflector may act as a air blade to redirect the hot air to the exterior surface of a glass window. Further, in some example embodiments, after being redirected by the deflector, the air may be ejected from one or more nozzles to target the air to the exterior surface of the glass window and increase the impact force with which the air contacts the exterior surface.

In some example embodiments, sensor data captured by one or more sensors may be evaluated to determine one or more parameters for controlling the diversion of air from a first region of a vehicle (e.g., a cargo area) to a second region of the vehicle (e.g., a rooftop sensor assembly). The sensor data may include, without limitation, temperature data inside the first region and/or the second region of the vehicle; data indicative of an extent to which transparent portions of a sensor housing in the second vehicle region are obscured (whether by condensation, debris, water droplets, or the like); data indicative of conditions in the vehicle's external environment (e.g., wind speeds experienced by the rooftop sensor assembly); and so forth. In example embodiments, the parameters controlled based on the sensor data may include, without limitation, a motor speed for a blower in the first region of the vehicle; a duration of time that the blower is operating; the position of air vents or similar structures for adjusting the direction of airflow in the first region and/or the second region of the vehicle; and so forth. In this manner, the delivery of heated air from the first region of the vehicle (e.g., the cargo area) to the second region of the vehicle (e.g., a rooftop sensor assembly) can be optimized to provide the most efficient cleaning functions for sensors located in the second vehicle region.

Example embodiments of the disclosed technology provide technical solutions to the technical problems presented by conventional sensor maintenance/cleaning techniques. As previously noted, these technical problems include decreased vehicle efficiency and driving range resulting from the increased vehicle weight caused by the conventional requirement for more equipment (e.g., fans/blowers, heaters, etc.) to clean transparent portions of a sensor housing as well as the greater number of potential points of failure in the vehicle that are introduced by such equipment. In particular, example embodiments of the disclosed technology provide a technical solution that obviates the need for any equipment to be provided specifically to clean transparent portions of a sensor housing of a rooftop sensor assembly, for example. This technical solution is provided in the form of a blower provided in a cargo area of a vehicle that is adapted to divert hot air in the cargo area to the rooftop sensor assembly to be used to clean (e.g., defrost, remove debris, etc.) transparent portions of a sensor housing of the sensor assembly.

Thus, the technical solution provided by embodiments of the disclosed technology eliminates the need for the additional equipment that would otherwise be required by conventional solutions for performing the aforementioned cleaning functions, thereby eliminating or at least mitigating the aforementioned technical problems associated with such conventional solutions. In addition, the diversion of already hot air from the cargo area yields more efficient cleaning functions (e.g., better defogging of condensation on a transparent portion of the sensor housing) than would be provided by a blower alone. Further, the diversion of already hot air from the cargo area not only eliminates the need for a blower/fan to be provided in proximity to the sensor housing, but also eliminates any need to provide a heater in proximity to the sensor housing, which would otherwise be required by conventional solutions that seek to circulate heated air within the sensor housing and across exterior surfaces of transparent portions of the housing. This, in turn, further reduces the amount of equipment that would otherwise be required by certain conventional sensor maintenance/cleaning techniques, thereby even further improving vehicle efficiency and driving range and further mitigating the risk of equipment failure.

### Illustrative Embodiments

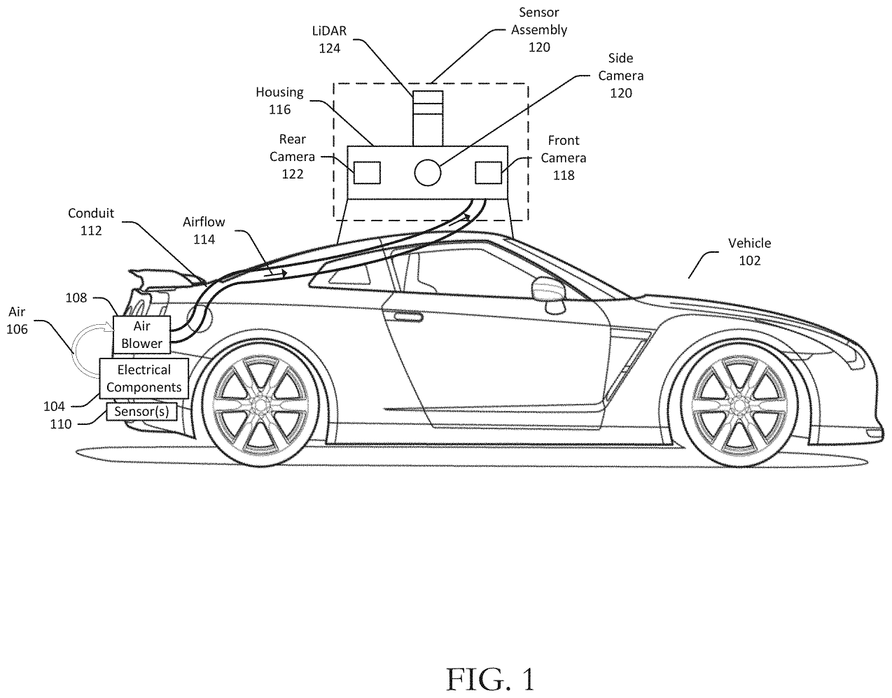

Various illustrative embodiments of the invention will now be described in connection with the various Figures. FIG. 1 illustrates an example configuration of an apparatus for performing sensor maintenance that is adapted to divert air from a vehicle cargo area to a sensor assembly located in a different region of the vehicle in accordance with an example embodiment of the disclosed technology. FIG. 1 depicts a vehicle 102. The vehicle 102 may be an autonomous vehicle capable of fully autonomous operation; a semi-autonomous vehicle capable of performing some but not all vehicle operations autonomously; or the like. In those example embodiments in which the vehicle 102 is a fully autonomous vehicle, a human driver is not required to be present in the vehicle 102 in order for the vehicle to operate; although a safety driver may nonetheless be present to comply with governmental regulations or due to safety/liability concerns. The vehicle 102 may be any suitable type of vehicle including, without limitation, a car; a truck; a vehicle with more than two axles; an armored vehicle; a two-wheeler vehicle; or the like.

The vehicle 102 includes a cargo area. In those embodiments in which the vehicle 102 is an autonomous vehicle, for example, the vehicle 102 may include various electrical components 104 located in the cargo area. The electrical components 104 may include various computing equipment (e.g., graphical processing units (GPUs)) configured to execute the complex processing associated with object perception, object tracking, and the like required to enable autonomous operation of the vehicle 102. In example embodiments, the electrical components 104 may emit a considerable amount of heat. The cargo area of the vehicle 102 may further include one or more sensors 110. The sensor(s) 110 may include, without limitation, a temperature sensor; an IR or other type of heat sensor, a smoke sensor, or the like. The sensors 110 may capture sensor data continuously or at periodic intervals.

In example embodiments, the cargo area of the vehicle 102 may further include an air blower 108 (e.g., a fan) adapted to divert air 106 from the cargo area towards an inlet of a conduit 112. The conduit 112 may be, for example, flexible tubing, hard tubing, or the like. In example embodiments, the conduit 112 may extend from the cargo area of the vehicle 102 (or more generally a first region of the vehicle 102) to a sensor assembly 120 provided in a second region of the vehicle 102. In example embodiments, the first region of the vehicle 102 (e.g., the cargo area) and the second region of the vehicle 102 (e.g., a region where the sensor assembly 120 is provided) may be non-contiguous. The term non-contiguous, as used herein, may refer to two regions of the vehicle 102 that are separated by one or more vehicle structures so as to preclude air from diffusing on its own between the two regions. In some example embodiments, a single conduit 112 (e.g., a single tube) may extend from the cargo area of the vehicle 102 to the vehicle region that includes the sensor assembly 120. In other example embodiments, multiple conduits (e.g., multiple pieces of tubing and connections there between) may be provided to carry the air 106 from the cargo area to the sensor assembly 120. In some example embodiments, valves or other mechanical structures may be provided at an inlet of the conduit 112, an outlet of the conduit 112, or anywhere along the length of the conduit 112 to control airflow 114 through the conduit 112.

Referring now to the sensor assembly 120 in more detail, the sensor assembly 120 may include a LiDAR 124 centrally located within the assembly 120. The assembly 120 may further include multiple cameras. The cameras may be positioned circumferentially around the central LiDAR 124. The cameras may include one or more front cameras 118, one or more side cameras 120, and one or more rear cameras 122 (each of which may be referred to in the singular hereinafter for ease of explanation). The cameras may be enclosed within a sensor housing 116 designed to protect the cameras from exposure to rain, wind, extreme temperatures, etc. in the external environment.

The housing 116 may include transparent portions (e.g., glass windows) that respectively oppose the cameras, and via which the cameras are provided respective FOVs of the external environment. For instance, the front camera 118 may be provided—via a corresponding transparent portion of the housing 116—with a FOV of the external environment that lies in front of the vehicle 102 (assuming a forward direction of travel of the vehicle 102). Similarly, the rear camera 122 and the side camera 120 may be provided—via corresponding transparent portions of the housing 116—with FOVs of the external environment that lie behind (assuming a forward direction of travel of the vehicle 102) and laterally next to, respectively, the vehicle 102.

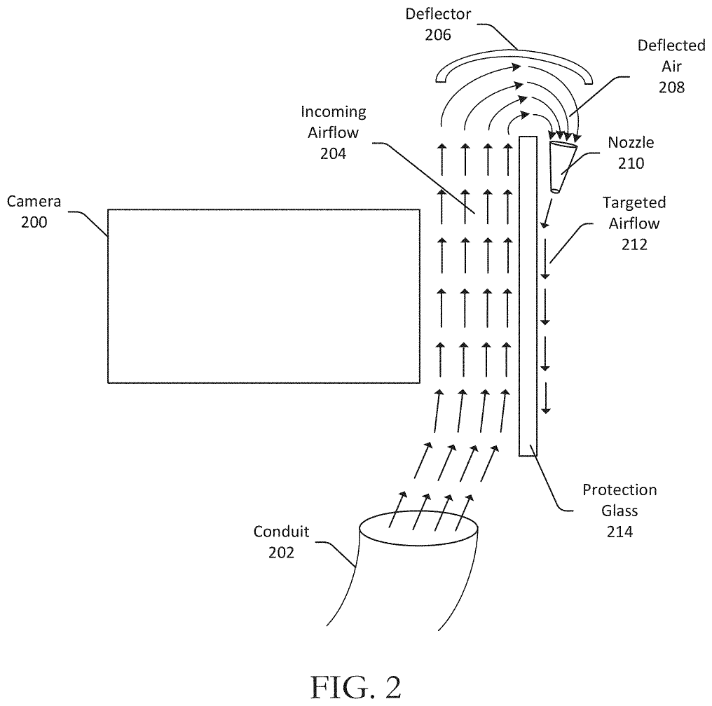

As previously noted, the aforementioned transparent portions of the housing 116, which may be, for example, glass windows, may become obscured for various reasons. For instance, condensation may develop on interior surfaces of the glass windows due to a temperature differential between the interior of the housing 116 and the external environment. Further, debris, water (e.g., water droplets), condensation, etc. may obscure an exterior surface of a glass window. In example embodiments, the hot air 106 diverted by the blower 108 from the cargo area to the sensor assembly 120 via the conduit 112 may be applied to the surfaces of the glass windows of the housing 116 to eliminate, or at a minimum mitigate, the accumulation of condensation, debris, etc. from the glass window surfaces. In this manner, the diverted air 106 provides cleaning functions for both interior and exterior surfaces of the glass windows and eliminates the need to provide separate equipment (e.g., separate blowers/fans) in proximity to the sensor assembly 120 to perform these functions. The manner by which the diverted air 106 provides these cleaning functions will be described in more detail in reference to FIG. 2.

FIG. 2 illustrates an example configuration of an apparatus provided in or otherwise in proximity to the sensor assembly 120, and which is adapted to utilize the diverted air 106 to perform cleaning functions with respect to the transparent portions of the housing 116. FIG. 2 depicts a cross-sectional view of a camera 200. The camera 200 may be any of the cameras shown in FIG. 1. Also depicted in FIG. 2 is a protection glass 214. The protection glass 214 may be, for example, a glass window of the housing 116 that provides a FOV of an external vehicle environment for a corresponding camera contained in the housing 116. A single camera 200 and a single corresponding glass window (protection glass 214) are shown in FIG. 2, while the other details of the housing 116 are excluded for simplicity of depiction.

As shown in FIG. 2, incoming air 204 may enter the housing 116 through an outlet of a conduit 202. The conduit 202 may be the same as the conduit 112 shown in FIG. 1 or part of a set of interconnected conduits that includes both the conduit 202 and the conduit 112. The incoming airflow 204 may include hot air that is diverted from a cargo area of the vehicle 102, for example. The airflow 204 may contact an interior surface of the protection glass 214, and the heat in the air may remove condensation that may have built up on the interior surface of the glass 212. Alternatively, even if there is no current condensation on the interior surface of the glass 214, the hot air 204 may nonetheless be diverted into the gap between the camera 200 and the glass 214 if a temperature sensor provided in or in proximity to the housing 116 indicates at least a threshold temperature differential between the interior of the housing 116 and the external environment, and thus, there exists a reasonable likelihood that condensation may develop based on the temperature differential.

The apparatus depicted in FIG. 2 may also include a deflector 206 that redirects the airflow 204. The deflector 206 may have a concave shape as depicted. Alternatively, the deflector 206 may have some portions that are concave, some portions that are convex, and/or some portions that have a substantially flat contour. In some example embodiments, the deflector 206 may be located entirely outside of the sensor housing 116, In other example embodiments, the deflector 206 may be located entirely within the housing 116. In still other example embodiments, the deflector 206 may be located partially within the housing and partially outside of the housing.

In example embodiments, the deflector 206 may be adapted to deflect the incoming airflow 204 and direct the deflected air 208 towards an opening of a nozzle 210, which may be adapted to eject the air as a targeted airflow 212 towards an exterior surface of the glass 214. In example embodiments, the nozzle 210 may be connected to a fluid line (e.g., tubing) that receives the deflected air 208 and carries the deflected air 208 to a head of the nozzle 210, and ultimately to a tip of the nozzle 210 from which the deflected air 208 is ejected in a targeted airflow 212 towards the exterior surface of the glass 214. In those example embodiments in which the deflector 206 is entirely or partially located outside of the sensor housing 116, the deflected air 208 may be redirected directly into the nozzle 210.

In example embodiments, the nozzle 210 may be adapted to adjust one or more characteristics of the targeted airflow 212 such as flow rate, speed, direction, pressure, or the like. For instance, the nozzle 210 may be controlled to cover the entire surface of the glass 214 according to a predetermined cleaning pattern. In some example embodiments, the nozzle 210 may be controlled to target particular parts of the exterior surface of the glass 214 (e.g., portions that have more debris, liquid, etc.) with a greater pressure, speed, flow rate, or the like and/or target particular portions of the exterior surface for a longer duration of time. In some example embodiments, multiple nozzles 210 may be provided and each nozzle may be statically positioned or dynamically adjustable to target the airflow 212 to different portions of the exterior surface of the glass 214.

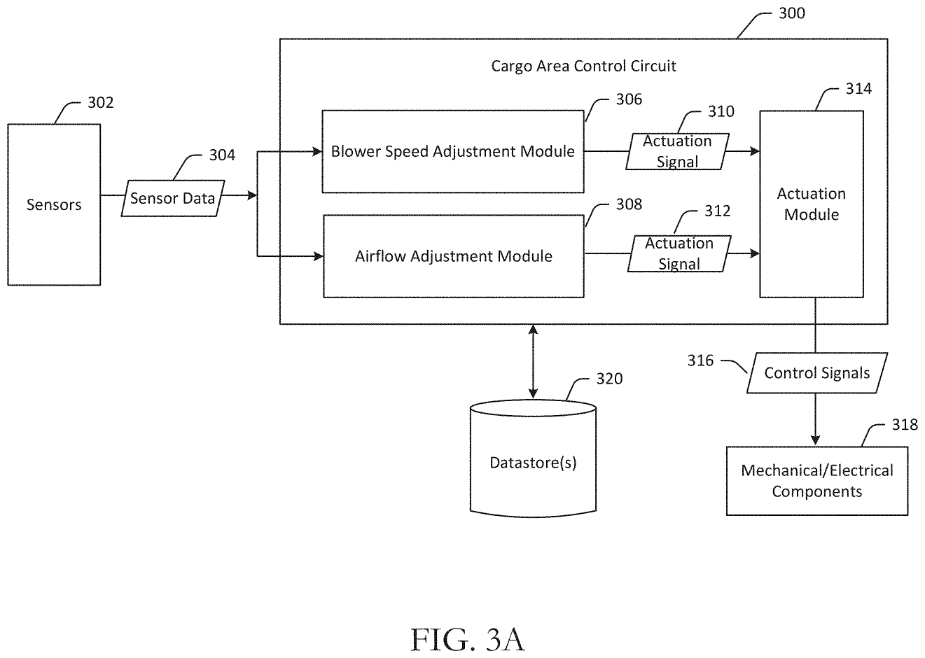

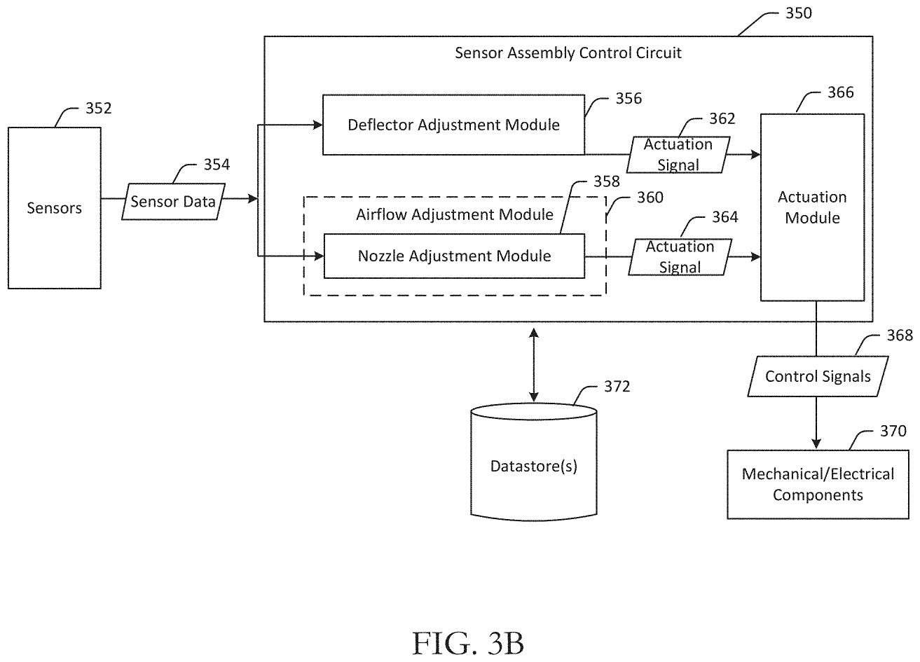

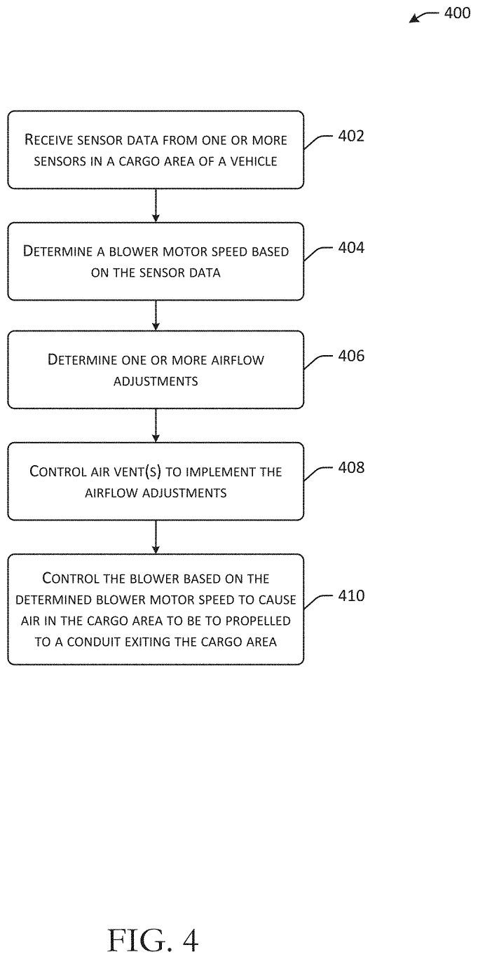

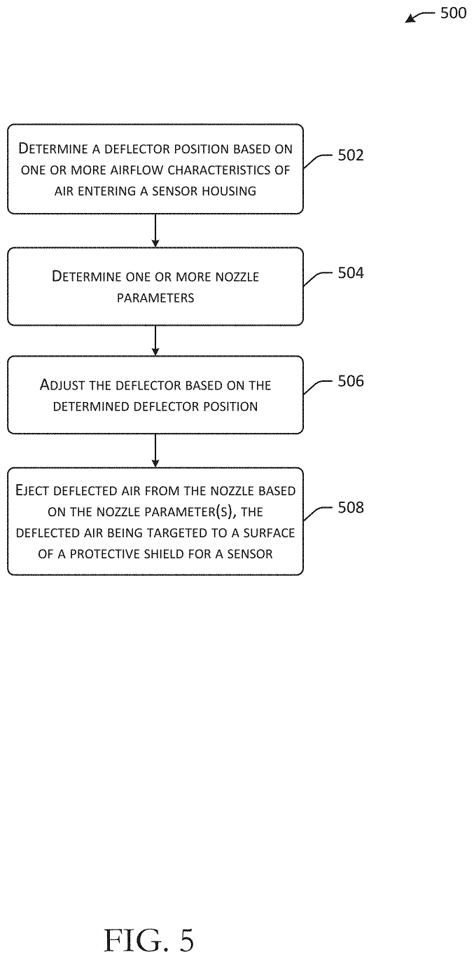

FIG. 3A is a data flow and block diagram illustrating operation of an apparatus adapted to divert air from a vehicle cargo area to another region of a vehicle, such as a region of the vehicle that includes a rooftop sensor assembly. FIG. 3B is a data flow and block diagram illustrating operation of an apparatus adapted to receive air diverted from a vehicle cargo area and utilize the diverted air to perform a cleaning function with respect to a transparent surface of a sensor housing, such as a housing that contains sensors (e.g., cameras) of a rooftop sensor assembly. FIG. 4 is a process flow diagram of an illustrative method 400 for controlling an apparatus whose operation is schematically depicted in FIG. 3A. Similarly, FIG. 5 is a process flow diagram of an illustrative method 500 for controlling an apparatus whose operation is schematically depicted in FIG. 3B. FIG. 4 will be described in conjunction with FIG. 3A and FIG. 5 will be described in conjunction with FIG. 3B hereinafter, with reference to FIG. 1 or 2 at times.

One or more operations of method 400 and/or method 500 can be performed by one or more of the engines/program modules depicted in FIG. 3A, 3B, or 6, whose operation will be described in more detail hereinafter. These engines/program modules can be implemented in any combination of hardware, software, and/or firmware. In certain example embodiments, one or more of these engines/program modules can be implemented, at least in part, as software and/or firmware modules that include computer-executable instructions that when executed by a processing circuit cause one or more operations to be performed. In example embodiments, these engines/program modules may be customized computer-executable logic implemented within a customized computing machine such as a customized field programmable gate array (FPGA), an application specific integrated circuit (ASIC), a programmable logic controller (PLC), or the like. A system or device described herein as being configured to implement example embodiments of the invention can include one or more processing circuits, each of which can include one or more processing units or cores. Computer-executable instructions can include computer-executable program code that when executed by a processing core can cause input data contained in or referenced by the computer-executable program code to be accessed and processed by the processing core to yield output data.

Referring now to FIG. 4 in conjunction with FIG. 3A, at block 402 of the method 400, a cargo area control circuit 300 may receive sensor data 304 from one or more sensors 302. In example embodiments, the cargo area control circuit 300 may be a customized computing device such as an FPGA, an ASIC, a PLC, or the like. In other example embodiments, the cargo area control circuit 300 may be implemented in firmware and/or software. The sensor(s) 302 may include any of the sensor(s) 110 of FIG. 1 including, without limitation, a temperature sensor, an IR sensor or other type of heat sensor, a moisture sensor, a smoke sensor, or the like. The sensor(s) 302 may further include one or more sensors located in a different region of the vehicle than the cargo area. For example, the sensor(s) 302 may include one or more sensors located in the region of the vehicle that receives the diverted air from the cargo area (e.g., sensor(s) located in proximity to the rooftop sensor assembly 120 of FIG. 1). The sensor data 304 may be received at periodic intervals or continuously over some period of time. In some example embodiments, the cargo area control circuit 300 may receive the sensor data 304 in real-time or near-real-time as it is captured by the sensors 302. In other example embodiments, the cargo area control circuit 300 may retrieve the sensor data 304 from one or more datastores 320.

At block 404 of the method 400, a blower speed adjustment module 306 of the cargo area control circuit 300 may determine a blower motor speed based on the received sensor data 304. The blower motor speed may be the speed at which a motor of the blower 108 (FIG. 1) is operated, which in turn, may correlate to an amount of the air 106 that is diverted from the cargo area to the sensor assembly 120 via the conduit 112. The blower speed adjustment module 306 may then generate and send an actuation signal 310 to an actuation module 314. The actuation signal 310 may indicate the determined blower motor speed.

In various example embodiments, the blower speed adjustment module 306 may determine/vary the blower motor speed based on an evaluation of different types of sensor data 304. As a non-limiting example, the blower motor speed may be directly correlated to the readings generated by a temperature sensor and/or a heat sensor in the cargo area. That is, as the temperature rises in the cargo area and/or the amount of heat generated by the electrical components 104 in the cargo area increases, the blower speed adjustment module 306 may determine that the blower motor speed should also increase so that a greater amount of the hotter air 106 can be diverted to the sensor assembly 120. Conversely, if the sensor data 304 indicates that the temperature and/or heat levels are dropping in the cargo area, the blower motor speed may be decreased.

Alternatively, in some other example embodiments, the blower speed adjustment module 306 may implement the opposite relationship between temperature/heat in the cargo area and the blower motor speed. In particular, in some example embodiments, the blower speed adjustment module 306 may determine that the blower motor speed should be increased if the temperature/heat in the cargo area decreases, in order to ensure that a sufficient amount of the less hot air 106 is diverted from the cargo area to the sensor assembly 120 to provide a suitable sensor maintenance/cleaning function. Conversely, in some example embodiments, the blower motor speed may be decreased if the temperature/heat levels in the cargo area rise because less of the now hotter air 106 may need to be diverted to provide a suitable sensor maintenance/cleaning function.

As another non-limiting example, the blower speed adjustment module 306 may determine the blower motor speed based at least in part on sensor data 304 received from sensors 302 that monitor conditions relating to the region of the vehicle to which the air 106 in the cargo area is diverted (e.g., the region that includes the sensor assembly 120). For instance, the sensor data 304 may include image data, moisture data, or the like that indicates an extent to which glass windows of the housing 116 are obscured by condensation, debris, liquid droplets, or the like. The blower speed adjustment module 306 may determine that the blower speed should be increased as the level of obscurement increases. As another non-limiting example, the sensor data 304 may include data indicative of a temperature differential between an inside of the housing 116 and the external environment. This temperature differential may be correlated with the likelihood that condensation will develop on interior surfaces of the glass windows of the housing 116 and/or the amount of condensation that develops. Thus, as the temperature differential increases, the blower speed adjustment module 306 may determine that the blower motor speed should correspondingly increase. It should be appreciated that the examples presented above relating to how the blower speed adjustment module 306 may determine an instantaneous or average blower motor speed based on various types of sensor data 304 are merely illustrative and not exhaustive.

In some example embodiments, the blower speed adjustment module 306 may employ one or more machine learning models to learn an instantaneous or average blower motor speed to use given currently observed sensor data. The machine learning models may employ supervised learning algorithms, semi-supervised learning algorithms, or unsupervised learning algorithms. The machine learning models may be trained using historical data as the ground-truth training data. The historical data may be stored in and retrieved from the datastore(s) 320 and may include historical sensor data for the cargo area (e.g., temperature data, heat sensor data, etc.) as well as historical sensor data relating to the vehicle region that includes the sensor assembly 120. The historical sensor data relating to the sensor assembly 120 may include, without limitation, temperature differential data indicative of historical temperature differentials between the interior of the sensor housing 116 and the external environment over time; data indicative of historical rates of condensation on a glass window; data indicative of historical rates of debris accumulation on a glass window; historical data indicative of instantaneous, average, or cumulative condensation amounts over various time periods; historical data indicative of instantaneous, average, or cumulative debris accumulation over various time periods; and so forth.

The machine learning models may be trained to learn correlations between sensor metrics for the cargo area of the vehicle and sensor metrics relating to the sensor assembly 120. For instance, certain temperature/heat sensor readings for the cargo area may be correlated with a greater rate of removal of condensation or debris from the glass windows of the sensor housing 116 and/or a lesser rate of condensation or debris accumulation on the glass windows. The machine learning models may learn to increase the blower motor speed when such temperature/heat sensor readings are observed. As another non-limiting example, based on the ground-truth training data, the machine learning models may learn that certain temperature differentials between the inside of the housing 116 and the outside environment, certain wind speeds, and/or certain other environmental conditions are more likely to lead to increased condensation and/or debris accumulation on the glass windows of the housing 116. As such, when such conditions are observed, the trained machine learning models may determine that the blower motor speed should be increased to divert more air from the cargo area to the sensor assembly 120. In some cases, the blower motor speed may be increased to divert more air regardless of how hot the air in the cargo area is.

Referring again to FIG. 4 in conjunction with FIG. 3A, at block 404 of the method 400, an airflow adjustment module 308 may determine one or more airflow adjustments based on the sensor data 304. Upon determining the airflow adjustments, the airflow adjustment module 308 may generate and send an actuation signal 312 to the actuation module(s) 314. The actuation signal 312 may indicate the airflow adjustments to be made. More specifically, in example embodiments, the cargo area of the vehicle 102 may be equipped with various components for redirecting the flow of air within the cargo area. Such components may include, for example, air vents that can be open, closed, moved laterally, or otherwise adjusted to direct the flow of air in the cargo area in various desired directions. In some example embodiments, the airflow adjustment components may also include one or more blowers/fans positioned in various locations in the cargo area to enhance the amount of air that is blown from particular areas within the cargo area. These additional blowers/fans may have smaller motors than the air blower 108, and thus, may only be adapted to move smaller volumes of air than the blower 108.

These airflow adjustment components (e.g., air vents, smaller blowers/fans, etc.) may operate to, for example, direct a greater volume of air from particular parts of the cargo area than from other parts of the cargo area. For instance, a smaller blower in a first part of the cargo area may be turned ON while another smaller blower in a second part of the cargo area may be turned OFF or the blower in the first part of the cargo area may be operated at a higher speed than the blower in the second part of the cargo area in order to direct more air to the main blower 108 from the first part of the cargo area than from the second part of the cargo area. Along similar lines, air vents may be positioned so as to direct more air to the blower 108 from the first part of the cargo area than the second part of the cargo area.

These airflow adjustments may be made if, for example, the air is hotter in a certain part of the cargo area than in another part. For instance, certain electrical components in the cargo area may be the primary sources of heat or all the electrical components together may be co-located in a particular part of the cargo area such that that part of the cargo area includes hotter air than other parts of the cargo area. In such example scenarios, the airflow adjustment module 308 may identify a set of airflow adjustments to direct more of the hotter air in the cargo area (e.g., the air in the vicinity of the electrical components) to the blower 108 for ultimate diversion to another region of the vehicle 102 (e.g., the vehicle region that includes the sensor assembly 120).

At block 408 of the method 400, the airflow adjustment components in the cargo area (e.g., air vents, smaller blowers, etc.) may be controlled so as to implement the airflow adjustments identified in the actuation signal 312. More specifically, the actuation module 314 may generate appropriate control signal(s) 316 based on the airflow adjustments indicated by the actuation signal 312, and may send the control signal(s) 316 to one or more mechanical and/or electrical components 318 to cause the airflow adjustments to be implemented. For instance, as part of implementing the determined airflow adjustments, a mechanical and/or electrical actuator may receive a control signal 316 and may physically adjust the position of an air vent based on the received control signal 316. In some example embodiments, different actuators may control different air vents and/or different blowers based on the control signals 316 to collectively implement the set of airflow adjustments indicated by the actuation signal 312.

At block 410 of the method 400, the actuation module 314 may generate one or more control signals 316 based on the actuation signal 310 received from the blower speed adjustment module 306. As previously noted, the actuation signal 310 may indicate a particular blower motor speed at which to operate the blower 108. The actuation module 314 may generate control signal(s) 316 based on the blower motor speed identified in the actuation signal 310 and may send the control signal(s) 316 to one or more mechanical/electrical components 318 to cause the motor of the blower 108 to be operated at the identified speed. This, in turn, ultimately causes air 106 in the cargo area to be diverted from the cargo area to an inlet of the conduit 112. The conduit 112 may then carry the air 106—potentially via one or more additional conduits—to another non-contiguous region of the vehicle (e.g., the vehicle region that includes the sensor assembly 120). For instance, the control signals 316 may include a voltage signal or a current signal that indicates an amount of voltage or current to apply to a motor (e.g., an electric motor) of the blower 108 to cause the blower 108 to operate at the desired speed. In example embodiments, the greater the blower motor speed, the faster blades of the blower 108 turn, and thus, the greater the volume of air 106 that is diverted to the conduit 112.

FIG. 5 illustrates an example method 500 for controlling an apparatus—whose operation is schematically depicted in FIG. 3B—that is adapted to receive air diverted from a vehicle cargo area and utilize the diverted air to perform a cleaning function with respect to transparent portions of a sensor housing. Referring now to FIG. 5 in conjunction with FIG. 3B, and in reference at times to FIGS. 1 and 2, at block 502 of the method 500, the deflector adjustment module 356 may determine a position of the deflector 206 based on one or more characteristics of the incoming airflow 204. In example embodiments, the deflector adjustment module 356 may form part of a sensor assembly control circuit 350, which may further include an airflow adjustment module 360, a nozzle adjustment module 358 (which may be a sub-module of the airflow adjustment module 360), and an actuation module 366. In example embodiments, the sensor assembly control circuit 350 may be a customized computing device such as an FPGA, an ASIC, a PLC, or the like. In other example embodiments, the sensor assembly control circuit 350 may be implemented in firmware and/or software. The sensor assembly control circuit 350 may be located within the sensor housing 116 or may otherwise be integrated with the sensor assembly 120. Alternatively, the sensor assembly control circuit 350 may be located in another region of the vehicle 102 but may be communicatively coupled to sensors 352 that monitor various conditions inside and outside in proximity to the sensor assembly 120.

In example embodiments, the sensor assembly control circuit 350 may receive sensor data 354 from the sensors 352. The sensors 352 may be located within the sensor assembly 120 or otherwise in proximity to the sensor assembly 120. The sensor(s) 352 may be configured to monitor and record data relating to various metrics including, without limitation, airflow characteristics of the incoming airflow 204; airflow characteristics of the deflected air 208; airflow characteristics of the targeted airflow 212; a temperature inside the sensor housing 116; a temperature outside the sensor housing 116; a temperature differential between the interior of the housing 116 and the external environment; a moisture level inside the housing 116; a moisture level outside the housing 116; a level of obscurement of the glass windows of the housing 116; an amount of debris, liquid, or the like obscuring the glass windows; an amount of condensation obscuring the glass windows; wind speed in proximity to the sensor assembly 120; and so forth.

The sensors 352 configured to capture data relating to such metrics may include, without limitation, one or more of the following: a volume air flow sensor; a mass air flow sensor; a temperature sensor; an IR sensor or other type of heat sensor; a moisture sensor; etc. The sensor assembly control circuit 350 may receive the sensor data 354 at periodic intervals or continuously over some period of time. In some example embodiments, the sensor assembly control circuit 350 may receive the sensor data 354 in real-time or near-real-time as it is captured by the sensors 352. In other example embodiments, the sensor assembly control circuit 350 may retrieve the sensor data 354 from one or more datastores 372.

In some example embodiments, at least some of the sensor data 354 captured by the sensors 352 may be sent to the cargo area control circuit 300 (FIG. 3A). That is, the sensor data 304 received by the cargo area control circuit 300 may include at least some of the sensor data 354. The sensor data 304 received by the cargo area control circuit 300 may include data relating to any of the metrics described above, in particular, any of the metrics indicative of conditions within the sensor housing 116 or outside of the sensor housing 116 but within proximity of the sensor assembly 120. For instance, the sensor data 304 received by the cargo area control circuit 300 may include any of the types of temperature data relating to the sensor assembly 120 described above (e.g., a temperature differential between the inside of the housing 116 and the external environment); any of the types of data indicative of a level of obscurement of the glass windows of the housing 116; and so forth.

As noted earlier, the sensor data 354 may include data indicative of airflow characteristics of the incoming airflow 204, which may include, for example, mass flow rate data, volume flow rate data, or the like. In particular, the data indicative of airflow characteristics of the incoming airflow 204 may indicate flow patterns in the incoming airflow 204, pockets of higher concentration of warmer air within the airflow 204, and so forth. In example embodiments, the deflector adjustment module 356 may analyze this data to determine an optimal position for the deflector 206 to deflect the greatest amount or volume of incoming air 204 towards the nozzle 210. In particular, the deflector adjustment module 356 may determine, based on the sensor data indicative of airflow characteristics of the incoming airflow 204, an optimal adjustment to be made to the deflector's 206 position to ensure that the deflected air 208 is targeted as efficiently as possible to the nozzle 210, and thus, to ensure that the incoming airflow 204 is utilized efficiently to generate the targeted airflow 212. The deflector adjustment module 356 may then generate an actuation signal 362 indicative of the determined deflector 206 position and send the actuation signal 362 to the actuation module 366.

At block 504 of the method 500, the nozzle adjustment module 358 may determine one or more nozzle parameters. In some example embodiments, the nozzle adjustment module 358 may determine the nozzle parameter(s) based on the sensor data 354. For instance, the sensor data 354 may include data indicative of a level of obscurement of an exterior surface of a glass window (e.g., the protection glass 214). As previously described, the data indicative of the level of obscurement of the protection glass 214 may include data from a moisture sensor that indicates the extent of moisture accumulation on the exterior surface of the protection glass 214; image data from an image sensor or data from a mass sensor that indicates an extent of debris accumulation on the exterior surface of the protection glass 214; and so forth. The nozzle adjustment module 358 may utilize this data to determine optimal positioning of the nozzle 210 with respect to the exterior surface of the protection glass 214.

For instance, the nozzle adjustment module 358 may determine that the nozzle 210 should be targeted to the areas containing a greater amount of moisture or debris accumulation for longer periods of time than other areas. As another non-limiting example, the nozzle adjustment module 358 may determine a path that the nozzle 210 should be programmed to traverse as it directs the targeted airflow 212 to the exterior surface of the protection glass 214. As yet another non-limiting example, the nozzle adjustment module 358 may determine the force/pressure at which to eject the targeted airflow 212 based on the data indicative of the level of obscurement of the exterior surface of the protection glass 214. In some example embodiments, the nozzle adjustment module 358 may determine that a lesser force/pressure is required for a given level of obscurement if wind speeds above a threshold amount are detected. Upon determining the nozzle parameter(s), the nozzle adjustment module 358 may generate an actuation signal 364 indicative of the determined nozzle parameter(s) and may send the actuation signal 364 to the actuation module 366.

In some example embodiments, the sensor assembly control circuit 350 may include an airflow adjustment module 360. The airflow adjustment module 360 may be configured to determine one or more adjustments to one or more of the incoming airflow 204, the deflected airflow 208, or the targeted airflow 212. The airflow adjustments may include adjustments to the positions of airflow adjustment components such as air vents to cause any of the aforementioned airflows to be redirected along different paths as desired. For instance, one or more air vents may be adjusted based on the airflow adjustments to cause more of the incoming airflow 204 to impinge the deflector 206. As another non-limiting example, air vents or the like may be adjusted to direct more of the deflected air 208 into the head of the nozzle 210. The nozzle adjustment module 358 is depicted as a potential sub-module of the airflow adjustment module 360 because, in some example embodiments, the nozzle parameters may be viewed as a type of airflow adjustment.

At block 506 of the method 500, the deflector 206 may be adjusted based on the determined deflector position. More specifically, the actuation module 366 may generate one or more control signals 368 based on the actuation signal 362 (which is indicative of the determined deflector position) and may send the control signal(s) 368 to one or more mechanical and/or electrical components 370 (e.g., a mechanical and/or electrical actuator) to cause the deflector 206 to be moved into the position determined as optimal by the deflector adjustment module 356.

Finally, at block 508 of the method 500, the deflected air 208 may be ejected from the nozzle 210 as the targeted airflow 212 based on the determined nozzle parameter(s). More specifically, the actuation module 366 may generate one or more control signals 368 based on the actuation signal 364 (which is indicative of the determined nozzle parameter(s)) and may send the control signal(s) 368 to one or more mechanical and/or electrical components 370 (e.g., a nozzle actuator) to activate and operate the nozzle 210 in accordance with the determined nozzle parameter(s).

Hardware Implementation

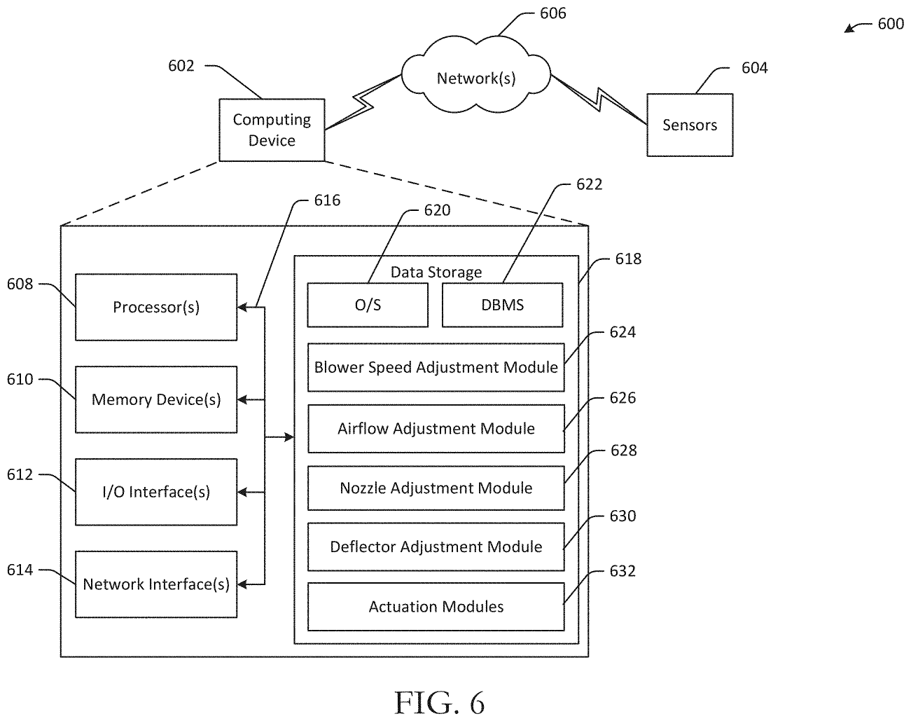

FIG. 6 is a schematic block diagram illustrating an example networked architecture 600 configured to implement example embodiments of the invention. The networked architecture 600 can include one or more special-purpose computing devices 602 communicatively coupled via one or more networks 606 to various sensors 604. The sensors 604 may include any of a variety of types of on-board vehicle sensors that may be provided with an autonomous vehicle including, without limitation, LiDAR sensors, radars, cameras, temperature sensors, moisture sensors, mass sensors, mass air flow sensors, volume air flow sensors, GPS receivers, sonar-based sensors, ultrasonic sensors, microphones, inertial measurement units (IMUs), accelerometers, gyroscopes, magnetometers, IR sensors or other types of heat sensors, and so forth. In example embodiments, the sensors 604 may include on-board sensors provided on an exterior or in an interior of a vehicle (e.g., vehicle 102) such as an autonomous vehicle. The special-purpose computing device(s) 602 may include devices that are integrated with a vehicle and may receive sensor data from the sensors 604 via a local network connection (e.g., WiFi, Bluetooth, Dedicated Short Range Communication (DSRC), or the like). In other example embodiments, the special-purpose computing device(s) 602 may be provided remotely from a vehicle and may receive the sensor data from the sensors 604 via one or more long-range networks.

The special-purpose computing device(s) 602 may be hard-wired to perform the techniques of example embodiments of the invention; may include circuitry or digital electronic devices such as one or more ASICs or FPGAs that are persistently programmed to perform the techniques; and/or may include one or more hardware processors programmed to perform the techniques pursuant to program instructions in firmware, memory, other storage, or a combination thereof. The special-purpose computing device(s) 602 may also combine custom hard-wired logic, ASICs, or FPGAs with custom programming to accomplish the techniques. The special-purpose computing device(s) 602 may be desktop computer systems, server computer systems, portable computer systems, handheld devices, networking devices or any other device or combination of devices that incorporate hard-wired and/or programmed logic to implement the techniques.

The special-purpose computing device(s) may be generally controlled and coordinated by operating system software 620, such as iOS, Android, Chrome OS, various versions of the Windows operating system, Unix, Linux, SunOS, Solaris, iOS, Blackberry OS, VxWorks, or other compatible operating systems. In other embodiments, the computing device(s) 602 may be controlled by a proprietary operating system. The operating system software 620 may control and schedule computer processes for execution; perform memory management; provide file system, networking, and I/O services; and provide user interface functionality, such as a graphical user interface (“GUI”).

While the computing device(s) 602 and/or the sensors 604 may be described herein in the singular, it should be appreciated that multiple instances of any such component can be provided and functionality described in connection any particular component can be distributed across multiple instances of such a component. In certain example embodiments, functionality described herein in connection with any given component of the architecture 600 can be distributed among multiple components of the architecture 600. For example, at least a portion of functionality described as being provided by a computing device 602 may be distributed among multiple such computing devices 602.

The network(s) 606 can include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 606 can have any suitable communication range associated therewith and can include, for example, global networks (e.g., the Internet), metropolitan area networks (MANs), wide area networks (WANs), local area networks (LANs), or personal area networks (PANs). In addition, the network(s) 606 can include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the computing device 602 can include one or more processors (processor(s)) 608, one or more memory devices 610 (generically referred to herein as memory 610), one or more input/output (“I/O”) interface(s) 612, one or more network interfaces 614, and data storage 618. The computing device 602 can further include one or more buses 616 that functionally couple various components of the computing device 602. The data storage may store one or more engines, program modules, components, or the like including, without limitation, a blower speed adjustment module 624, an airflow adjustment module 626, a nozzle adjustment module 628, a deflector adjustment module 630, and actuation modules 632. Each of the engines/components depicted in FIG. 6 may include logic for performing any of the processes or tasks described earlier in connection with correspondingly named engines/components. In certain example embodiments, any of the depicted engines/components may be implemented in hard-wired circuitry within digital electronic devices such as one or more ASICs or FPGAs that are persistently programmed to perform corresponding techniques.

The bus(es) 616 can include at least one of a system bus, a memory bus, an address bus, or a message bus, and can permit the exchange of information (e.g., data (including computer-executable code), signaling, etc.) between various components of the computing device 602. The bus(es) 616 can include, without limitation, a memory bus or a memory controller, a peripheral bus, an accelerated graphics port, and so forth. The bus(es) 616 can be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 610 can include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, can include non-volatile memory. In certain example embodiments, volatile memory can enable faster read/write access than non-volatile memory. However, in certain other example embodiments, certain types of non-volatile memory (e.g., FRAM) can enable faster read/write access than certain types of volatile memory.

In various implementations, the memory 610 can include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 610 can include main memory as well as various forms of cache memory such as instruction cache(s), data cache(s), translation lookaside buffer(s) (TLBs), and so forth. Further, cache memory such as a data cache can be a multi-level cache organized as a hierarchy of one or more cache levels (L1, L2, etc.).

The data storage 618 can include removable storage and/or non-removable storage including, but not limited to, magnetic storage, optical disk storage, and/or tape storage. The data storage 618 can provide non-volatile storage of computer-executable instructions and other data. The memory 610 and the data storage 618, removable and/or non-removable, are examples of computer-readable storage media (CRSM) as that term is used herein. The data storage 618 can store computer-executable code, instructions, or the like that can be loadable into the memory 610 and executable by the processor(s) 608 to cause the processor(s) 608 to perform or initiate various operations. The data storage 618 can additionally store data that can be copied to memory 610 for use by the processor(s) 608 during the execution of the computer-executable instructions. Moreover, output data generated as a result of execution of the computer-executable instructions by the processor(s) 608 can be stored initially in memory 610 and can ultimately be copied to data storage 618 for non-volatile storage.

More specifically, the data storage 618 can store one or more operating systems (O/S) 620 and one or more database management systems (DBMS) 622 configured to access the memory 610 and/or one or more external datastore(s) (not depicted) potentially via one or more of the networks 606. In addition, the data storage 618 may further store one or more program modules, applications, engines, computer-executable code, scripts, or the like. For instance, any of the engines/components depicted in FIG. 6 may be implemented as software and/or firmware that includes computer-executable instructions (e.g., computer-executable program code) loadable into the memory 610 for execution by one or more of the processor(s) 608 to perform any of the techniques described herein.

Although not depicted in FIG. 6, the data storage 618 can further store various types of data utilized by engines/components of the computing device 602. Such data may include, without limitation, current sensor data, historical sensor data (e.g., ground-truth training data), etc. Any data stored in the data storage 618 can be loaded into the memory 610 for use by the processor(s) 608 in executing computer-executable program code. In addition, any data stored in the data storage 618 can potentially be stored in one or more external datastores that are accessible via the DBMS 622 and loadable into the memory 610 for use by the processor(s) 608 in executing computer-executable instructions/program code.

The processor(s) 608 can be configured to access the memory 610 and execute computer-executable instructions/program code loaded therein. For example, the processor(s) 608 can be configured to execute computer-executable instructions/program code of the various engines/components of the computing device 602 to cause or facilitate various operations to be performed in accordance with one or more embodiments of the invention. The processor(s) 608 can include any suitable processing unit capable of accepting data as input, processing the input data in accordance with stored computer-executable instructions, and generating output data. The processor(s) 608 can include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 608 can have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 608 can be made capable of supporting any of a variety of instruction sets.

Referring now to other illustrative components depicted as being stored in the data storage 618, the 0/S 620 can be loaded from the data storage 618 into the memory 610 and can provide an interface between other application software executing on the computing device 602 and hardware resources of the computing device 602. More specifically, the 0/S 620 can include a set of computer-executable instructions for managing hardware resources of the computing device 602 and for providing common services to other application programs. In certain example embodiments, the 0/S 620 can include or otherwise control execution of one or more of the engines/program modules stored in the data storage 618. The O/S 620 can include any operating system now known or which can be developed in the future including, but not limited to, any server operating system, any mainframe operating system, or any other proprietary or non-proprietary operating system.

The DBMS 622 can be loaded into the memory 610 and can support functionality for accessing, retrieving, storing, and/or manipulating data stored in the memory 610, data stored in the data storage 618, and/or data stored in external datastore(s) (not shown in FIG. 6). The DBMS 622 can use any of a variety of database models (e.g., relational model, object model, etc.) and can support any of a variety of query languages. The DBMS 622 can access data represented in one or more data schemas and stored in any suitable data repository. Datastore(s) that may be accessible by the computing device 602 via the DBMS 622, can include, but are not limited to, databases (e.g., relational, object-oriented, etc.), file systems, flat files, distributed datastores in which data is stored on more than one node of a computer network, peer-to-peer network datastores, or the like.

Referring now to other illustrative components of the computing device 602, the input/output (I/O) interface(s) 612 can facilitate the receipt of input information by the computing device 602 from one or more I/O devices as well as the output of information from the computing device 602 to the one or more I/O devices. The I/O devices can include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components can be integrated into the computing device 602 or can be separate therefrom. The I/O devices can further include, for example, any number of peripheral devices such as data storage devices, printing devices, and so forth.

The I/O interface(s) 612 can also include an interface for an external peripheral device connection such as universal serial bus (USB), FireWire, Thunderbolt, Ethernet port or other connection protocol that can connect to one or more networks. The I/O interface(s) 612 can also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The computing device 602 can further include one or more network interfaces 614 via which the computing device 602 can communicate with any of a variety of other systems, platforms, networks, devices, and so forth. The network interface(s) 614 can enable communication, for example, with the sensors 604 and/or one or more other devices via one or more of the network(s) 606. In example embodiments, the network interface(s) 614 provide a two-way data communication coupling to one or more network links that are connected to one or more of the network(s) 606. For example, the network interface(s) 614 may include an integrated services digital network (ISDN) card, a cable modem, a satellite modem, or a modem to provide a data communication connection to a corresponding type of telephone line. As another non-limiting example, the network interface(s) 614 may include a local area network (LAN) card to provide a data communication connection to a compatible LAN (or a wide area network (WAN) component to communicate with a WAN). Wireless links may also be implemented. In any such implementation, the network interface(s) 614 may send and receive electrical, electromagnetic, or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP, in turn, may provide data communication services through the world wide packet data communication network now commonly referred to as the “Internet”. Local networks and the Internet both use electrical, electromagnetic, or optical signals that carry digital data streams. The signals through the various network(s) 606 and the signals on network links and through the network interface(s) 614, which carry the digital data to and from the computing device 602, are example forms of transmission media. In example embodiments, the computing device 602 can send messages and receive data, including program code, through the network(s) 606, network links, and network interface(s) 614. For instance, in the Internet example, a server might transmit a requested code for an application program through the Internet, the ISP, a local network, and a network interface 614. The received code may be executed by a processor 608 as it is received, and/or stored in the data storage 618, or other non-volatile storage for later execution.

It should be appreciated that the engines depicted in FIG. 6 as part of the computing device 602 are merely illustrative and not exhaustive. In particular, functionality can be modularized in any suitable manner such that processing described as being supported by any particular engine can alternatively be distributed across multiple engines, program modules, components, or the like, or performed by a different engine, program module, component, or the like. Further, one or more depicted engines may or may not be present in certain embodiments, while in other embodiments, additional engines not depicted can be present and can support at least a portion of the described functionality and/or additional functionality. In addition, various engine(s), program module(s), script(s), plug-in(s), Application Programming Interface(s) (API(s)), or any other suitable computer-executable code hosted locally on the computing device 602 and/or hosted on other computing device(s) (e.g., 602) accessible via one or more of the network(s) 606, can be provided to support functionality provided by the engines depicted in FIG. 6 and/or additional or alternate functionality. In addition, engines that support functionality described herein can be implemented, at least partially, in hardware and/or firmware and can be executable across any number of computing devices 602 in accordance with any suitable computing model such as, for example, a client-server model, a peer-to-peer model, and so forth.

It should further be appreciated that the computing device 602 can include alternate and/or additional hardware, software, and/or firmware components beyond those described or depicted without departing from the scope of the invention. More particularly, it should be appreciated that software, firmware, and/or hardware components depicted as forming part of the computing device 602 are merely illustrative and that some components may or may not be present or additional components may be provided in various embodiments. It should further be appreciated that each of the engines depicted and described represent, in various embodiments, a logical partitioning of supported functionality. This logical partitioning is depicted for ease of explanation of the functionality and may or may not be representative of the structure of software, hardware, and/or firmware for implementing the functionality.

In general, the terms engine, program module, or the like, as used herein, refer to logic embodied in hardware, firmware, and/or circuitry, or to a collection of software instructions, possibly having entry and exit points, written in a programming language, such as, for example, Java, C or C++. A software engine/module may be compiled and linked into an executable program, installed in a dynamic link library, or may be written in an interpreted programming language such as, for example, BASIC, Perl, or Python. It will be appreciated that software engines/modules may be callable from other engines/modules or from themselves, and/or may be invoked in response to detected events or interrupts. Software engines/modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. “Open source” software refers to source code that can be distributed as source code and/or in compiled form, with a well-publicized and indexed means of obtaining the source, and optionally with a license that allows modifications and derived works. Software instructions may be embedded in firmware and stored, for example, on flash memory such as erasable programmable read-only memory (EPROM). It will be further appreciated that hardware modules/engines may include connected logic units, such as gates and flip-flops, and/or may be further include programmable units, such as programmable gate arrays or processors.

Example embodiments are described herein as including engines or program modules. Such engines/program modules may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a field programmable gate array (FPGA) or an application specific integrated circuit (ASIC). A hardware engine may also include programmable logic or circuitry that is temporarily configured by software to perform certain operations. For example, a hardware engine may include a general-purpose processor or other programmable processor configured by software, in which case, the configured processor becomes a specific machine uniquely tailored to perform the configured functions and no longer constitute general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the term “engine” or “program module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware engines are temporarily configured (e.g., programmed), each of the hardware engines need not be configured or instantiated at any one instance in time. For example, where a hardware engine includes a general-purpose processor configured by software to become a special-purpose processor, the general-purpose processor may be configured as respectively different special-purpose processors (e.g., comprising different hardware engines) at different times. Software accordingly can configure a particular processor or processors, for example, to constitute a particular hardware engine at a given instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute an implementation of a hardware engine. Similarly, the methods described herein may be at least partially processor-implemented, with a particular processor or processors being an example of hardware. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations of example methods described herein may be distributed among multiple processors, not only residing within a single machine, but deployed across a number of machines. In some example embodiments, the processors may be located in a single geographic location (e.g., within a home environment, an office environment, or a server farm). In other example embodiments, the processors may be distributed across a number of geographic locations.

The present invention may be implemented as a system, a method, and/or a computer program product. The computer program product may include a computer readable storage medium (or media) having computer readable program instructions embodied thereon for causing a processor to carry out aspects of the present invention.

The computer readable storage medium is a form of non-transitory media, as that term is used herein, and can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. The computer readable storage medium, and non-transitory media more generally, may include non-volatile media and/or volatile media. A non-exhaustive list of more specific examples of a computer readable storage medium includes the following: a portable computer diskette such as a floppy disk or a flexible disk; a hard disk; a random access memory (RAM), a read-only memory (ROM), an erasable programmable read-only memory (EPROM or Flash memory), a static random access memory (SRAM), or any other memory chip or cartridge; a portable compact disc read-only memory (CD-ROM); a digital versatile disk (DVD); a memory stick; a solid state drive; magnetic tape or any other magnetic data storage medium; a mechanically encoded device such as punch-cards or raised structures in a groove having instructions recorded thereon or any physical medium with patterns of holes; any networked versions of the same; and any suitable combination of the foregoing.

Non-transitory media is distinct from transmission media, and thus, a computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Non-transitory media, however, can operate in conjunction with transmission media. In particular, transmission media may participate in transferring information between non-transitory media. For example, transmission media can include coaxial cables, copper wire, and/or fiber optics, including the wires that include at least some of the bus(es) 616. Transmission media can also take the form of acoustic or light waves, such as those generated during radio-wave and infra-red data communications.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider (ISP)). In some embodiments, electronic circuitry including, for example, programmable logic circuitry, FPGAs, or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The various features and processes described above may be used independently of one another or may be combined in various ways. All possible combinations and sub-combinations are intended to fall within the scope of the invention. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed partially, substantially, or entirely concurrently, or the blocks may sometimes be executed in the reverse order, depending upon the functionality involved.

It should be emphasized that many variations and modifications may be made to the above-described embodiments, the elements of which are to be understood as being among other example embodiments of the invention. All such modifications and variations are intended to be included herein within the scope of the invention. While example embodiments of the invention may be referred to herein, individually or collectively, by the term “invention,” this is merely for convenience and does not limit the scope of the invention to any single disclosure or concept if more than one is, in fact, disclosed. The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

The embodiments illustrated herein are described in sufficient detail to enable those skilled in the art to practice the teachings disclosed. Other embodiments may be used and derived therefrom, such that structural and logical substitutions and changes may be made without departing from the scope of the invention. The Detailed Description, therefore, is not to be taken in a limiting sense, and the scope of various embodiments is defined only by the appended claims, along with the full range of equivalents to which such claims are entitled.

Although the invention(s) have been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

As used herein, the term “or” may be construed in either an inclusive or exclusive sense. Moreover, plural instances may be provided for resources, operations, or structures described herein as a single instance. Additionally, boundaries between various resources, operations, program modules, engines, and/or datastores are somewhat arbitrary, and particular operations are illustrated in a context of specific illustrative configurations. Other allocations of functionality are envisioned and may fall within a scope of various embodiments of the invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the invention as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

What is claimed is:

1. A method for sensor maintenance, the method comprising:
receiving sensor data from one or more sensors configured to monitor at least a first region of a vehicle;
determining, based on the sensor data, one or more parameters for diverting air from the first region of the vehicle to a second region of the vehicle different from the first region; and
causing the air to be diverted from the first region of the vehicle to the second region of the vehicle based on the one or more parameters.

2. The method of claim 1, wherein determining the one or more parameters comprises determining a blower motor speed based on the sensor data, and wherein causing the air to be diverted from the first region of the vehicle to the second region of the vehicle comprises causing a motor of a blower in the first region of the vehicle to operate at the determined blower motor speed.

3. The method of claim 2, wherein the sensor data comprises temperature data indicative of a temperature of the air in the first region of the vehicle, and wherein determining the blower motor speed based on the sensor data comprises increasing the blower motor speed as the temperature of the air increases.

4. The method of claim 2, wherein the one or more sensors comprises at least one sensor configured to monitor the second region of the vehicle, and wherein the blower motor speed is determined based at least in part on a respective portion of the sensor data that is received from the at least one sensor.

5. The method of claim 4, wherein the second region of the vehicle comprises a sensor assembly comprising a camera and a protective shield that protects the camera from an external environment to the vehicle, and wherein the respective portion of the sensor data that is received from the at least one sensor comprises data indicative of at least one of an amount of moisture or an amount of debris present on the protective shield.

6. The method of claim 5, wherein determining the blower motor speed based on the sensor data comprises increasing the blower motor speed as the amount of moisture or the amount of debris present on the protective shield increases.

7. The method of claim 5, wherein the protective shield is provided as part of a sensor housing that encloses the camera, and wherein the protective shield comprises an interior glass surface that opposes the camera and an exterior glass surface exposed to the external environment.

8. The method of claim 7, wherein causing the air to be diverted from the first region of the vehicle to the second region of the vehicle comprises causing the air to be diverted from the first region of the vehicle to the interior glass surface of the sensor assembly via one or more conduits.

9. The method of claim 8, further comprising causing the air to be deflected after contact with the interior glass surface to redirect the air to the exterior glass surface.

10. The method of claim 1, wherein the first region of the vehicle is a cargo area of the vehicle comprising one or more electrical components that generate heat.

11. A system for sensor maintenance, the system comprising:
at least one processor; and
at least one memory storing computer-executable instructions, wherein the at least one processor is configured to access the at least one memory and execute the computer-executable instructions to:
receive sensor data from one or more sensors configured to monitor at least a first region of a vehicle;
determine, based on the sensor data, one or more parameters for diverting air from the first region of the vehicle to a second region of the vehicle different from the first region; and
cause the air to be diverted from the first region of the vehicle to the second region of the vehicle based on the one or more parameters.

12. The system of claim 11, wherein the at least one processor is configured to determine the one or more parameters by executing the computer-executable instructions to determine a blower motor speed based on the sensor data, and wherein the at least one processor is configured to cause the air to be diverted from the first region of the vehicle to the second region of the vehicle by executing the computer-executable instructions to cause a control signal to be generated and sent to a motor of a blower in the first region of the vehicle to cause the motor to operate at the determined blower motor speed.

13. The system of claim 12, wherein the sensor data comprises temperature data indicative of a temperature of the air in the first region of the vehicle, and wherein the at least one processor is configured to determine the blower motor speed based on the sensor data by executing the computer-executable instructions to increase the blower motor speed as the temperature of the air increases.

14. The system of claim 12, wherein the one or more sensors comprises at least one sensor configured to monitor the second region of the vehicle, and wherein the blower motor speed is determined based at least in part on a respective portion of the sensor data that is received from the at least one sensor.

15. The system of claim 14, wherein the second region of the vehicle comprises a sensor assembly comprising a camera and a protective shield that protects the camera from an external environment to the vehicle, and wherein the respective portion of the sensor data that is received from the at least one sensor comprises data indicative of at least one of an amount of moisture or an amount of debris present on the protective shield.

16. The system of claim 15, wherein the at least one processor is configured to determine the blower motor speed based on the sensor data by executing the computer-executable instructions to increase the blower motor speed as the amount of moisture or the amount of debris present on the protective shield increases.

17. The system of claim 15, wherein the protective shield is provided as part of a sensor housing that encloses the camera, and wherein the protective shield comprises an interior glass surface that opposes the camera and an exterior glass surface exposed to the external environment.

18. The system of claim 17, wherein the air is diverted from the first region of the vehicle to the interior glass surface of the sensor assembly via one or more conduits.

19. An apparatus for sensor maintenance, the apparatus comprising:
a blower provided in a first region of a vehicle;
one or more conduits for carrying a fluid; and
a controller configured to:
receive sensor data from one or more sensors configured to monitor at least the first region of the vehicle; and
activate the blower based on the sensor data to cause air in the first region of the vehicle to be diverted via the one or more conduits to a second region of the vehicle.

20. The apparatus of claim 19, wherein the second region of the vehicle is non-contiguous with the first region of the vehicle.
